(19) United States
(12) Patent Application Publication
(10) Pub. No.: US 2025/0117605 A1
(43) Pub. Date: Apr. 10, 2025

(54) CONTENT ASSISTANCE PROCESSES FOR FOUNDATION MODEL INTEGRATIONS

(71) Applicant: Microsoft Technology Licensing, LLC, Redmond, WA (US)

(72) Inventors: Adrian DE WYNTER, Snohomish, WA (US); Xun WANG, Amherst, MA (US); Siqing CHEN, Bellevue, WA (US); Xinyu HE, Vancouver (CA); Qilong GU, Redmond, WA (US); Mark William JOHNSON, Seattle, WA (US); Utsab BOSE, Bellevue, WA (US); Olivier GAUTHIER, Duvall, WA (US)

(21) Appl. No.: 18/484,184

(22) Filed: Oct. 10, 2023

(51) Int. Cl. G06F 40/56; G06F 40/279

(52) U.S. Cl. CPC G06F 40/56; G06F 40/279

(57) ABSTRACT

Technology is disclosed herein for content assistance processes via foundation model integrations in software applications. In an implementation, a computing device receives natural language input from a user relating to content of a document in a user interface of an application. The computing device generates a first prompt for a foundation model to generate at least a completion to the natural language input. The computing device receives a reply to the first prompt from the foundation model which includes a completion to the natural language input. The computing device causes display of the completion in association with the natural language input in the user interface and receives user input comprising an indication to combine the input and the completion, resulting in a revised natural language input. The computing device submits a second prompt including the revised natural language input to the foundation model.

### TECHNICAL FIELD

Aspects of the disclosure are related to the field of computing hardware and software and, in particular, to the integration of foundation models and software applications.

### BACKGROUND

Content assistants in software applications assist users with creating and editing content in software applications, such as in word processing applications, spreadsheet applications, and so on. These assistants are often powered by AI models or engines trained for tasks relating to content generation and ideation. A content assistant may provide a conversational user interface by which the user can ask for help with developing content, editing or improving the readability of the user's own content, and so on. On the backend, the content assistant may interface with a foundation model for content and ideas. Foundation models, including large language models and other generative architectures, are trained on an immense amount of data across virtually every domain of the arts and sciences. This training allows the models to learn a rich representation of language which in turn allows them to generate creative and unexpected content in response to a user's request.

Despite the availability of content assistants, users are often unable to fully exploit the capabilities of such tools due to an inability to articulate their intent, a lack of background knowledge of a topic of interest, a lack of confidence in one's writing ability, or simply not knowing where or how to begin. Moreover, a user lacking an understanding or intuition about foundation models may be unable to fully exploit the capabilities of the foundation models. Users may resort to canned or boilerplate prompts, but these one-size-fits-all approaches may fail to harness the creativity that these models are capable of, which is an important advantage of using foundation models for content generation.

### Overview

Technology is disclosed herein for content assistance via a foundation model integration in various implementations. In an implementation, a computing device receives a natural language input from a user relating to the document in a user interface of an application. The computing device generates a first prompt to elicit a reply from a foundation model which tasks the foundation model with generating at least a completion to the natural language input. The first prompt includes at least a portion of the natural language input, a task associated with the natural language input, and context information associated with the document. The computing device receives a reply to the first prompt from the foundation model including the completion to the natural language input. The computing device causes display of the completion in association with the natural language input in the user interface and receives user input comprising an indication to combine the natural language input and the completion, resulting in a revised natural language input. The computing device submits a second prompt to the foundation model including the revised natural language input.

In some implementations, the computing device receives a second reply generated by the foundation model in response to the second prompt and populates the document with content from the second reply according to the task. In an implementation, the context information includes a portion of the content from the document selected according to the task associated with the natural language input.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for content assistance via a foundation model integration in an implementation.

FIG. 2 illustrates a process for content assistance via a foundation model integration in an implementation.

FIG. 3 illustrates a systems architecture for content assistance via a foundation model integration in an implementation.

FIGS. 4A and 4B illustrate a workflow for content assistance via a foundation model integration in an implementation.

FIG. 5 illustrate a workflow for content assistance via a foundation model integration in an implementation.

FIG. 6 illustrates a workflow for content assistance via a foundation model integration in an implementation.

FIG. 7 illustrates a user experience for content assistance via a foundation model integration in an implementation.

FIG. 8 illustrates a user experience for content assistance via foundation model integration in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for content assistance, including input contextualization, via foundation model integrations in software applications, such as word processing or other types of productivity applications. In a brief illustration of the technology, a user may open a blank document with the intent of writing an essay relating to travel, such as travel to Norway. The application service may surface an input pane into which the user enters a natural language question or request about the topic: “I want to write about visiting Norway.” Because a user's input may be interpreted in different ways, the application generates an initial prompt for the foundation model for generating a completion which will contextualize the user input. The initial prompt tasks the foundation model with generating the completion to the user input according to a specified task and contextual information from the document. Based on the initial prompt, the foundation model suggests a completion to the user input which, upon submission in a subsequent prompt, may yield higher quality output or output which is more useful to the user than would otherwise be produced. In generating an initial prompt for requesting a completion to the user input, the application may include a portion of the existing content of the document in the initial prompt. For example, the existing content may be a paragraph directed to tourism, to an interest in recreational activities, or to an interest in European history. Absent information about the existing content, a broadly worded input such as “I want to write about visiting Norway” may fail to yield material that is appropriate for the user's intent. Incorporating contextual information drawn from existing content into the initial prompt will enable the foundation model to infer the user's intent and tailor the completion to enable the foundation model to generate appropriate material in response to the subsequent prompt.

Continuing the illustrative example, the foundation model may be tasked in the initial prompt with generating a concise completion to the thought expressed in the user input which can be rapidly assimilated by the user for acceptance or rejection and which causes the foundation model, in response to a subsequent prompt, to generate higher quality output than might be obtained by the user input alone. Upon submitting the initial prompt to the foundation model, the application receives a suggestion for completing or augmenting the input and surfaces the suggestion in association with the user input in the input pane: “I want to write about visiting Norway to explore the fjords.” When the user indicates an acceptance of the suggested completion, the application generates a subsequent prompt with the revised user input (i.e., the user input with the completion) which tasks the foundation model with generating content responsive to the input and completion, then populates the document with the newly generated content.

In various implementations of the technology, the user enters a natural language input in a user interface of the application, such as keying in a request in a textbox or chat pane of a content assistant of the application. As the user enters the input, the content assistant generates an initial prompt for submission to a foundation model. When the content assistant detects a pause in the entry (e.g., a pause in entering the user input exceeding one second), the content assistant populates the initial prompt with the user input along with a task and contextual information and submits the initial prompt to the foundation model. If the user continues to enter the input or changes the input, the application may revise or update the initial prompt prior to submission.

The initial prompt generated by the content assistant for the user input tasks a foundation model, such as a large language model (LLM), with generating a completion for the natural language input. The completion may be a refinement or narrowing of the input topic (e.g., additional information for the input), suggestion for how the input may be addressed by foundation model (e.g., “I want to write about Norway. List ten popular tourist sites in Norway.”), or other addition to the user input based on an inference made by the foundation model of the user's intent. The completion generated by the foundation model may be one or more words which form a phrase, sentence, paragraph, etc., which may be appended to the user input resulting in revised user input. The completion may continue or complete an incomplete user input, or the completion may be a sentence appended to the end of the user input.

In addition to the user input, the content assistant includes a task associated with the user input in the initial prompt. The task may be received from a task engine of the application or identified by the content assistant based on contextual factors. The initial prompt also includes contextual information relating to content of the document, such as a portion of the existing content to inform the foundation model of the topic of the document as well as the sophistication of the writing. In some scenarios, the contextual information will indicate that the document lacks any existing content. The initial prompt tasks the foundation model with generating a completion to the input in accordance with its training and in reference to the task and the context information.

Upon submitting the initial prompt to the foundation model, the application receives a reply which includes a completion to the natural language input. In some scenarios, the foundation model may be tasked with generating multiple completions which are suggested to the user in the input pane. The application parses the reply to extract the completions and processes the completions according to rules for suitability (e.g., sensitivity and appropriateness). Some completions may be filtered out at the processing stage due to being unsuitable.

Having parsed the reply and processed a completion from the foundation model, the application surfaces the completion in the user interface in association with the natural language input. In various implementations, to avoid untimely surfacing of the completion in the user interface, the application tracks the latency associated with generating the initial prompt to producing a displayable completion and surfaces the completion so long as the latency does not exceed a threshold value. By tracking latency, completions are more likely to be presented to the user in a timely manner and to avoid, for example, interrupting or distracting the user with a tardy suggestion. In some implementations, various methods are applied to the generating the initial prompt to reduce the latency, such as minimizing the initial prompt size, constraining the size (e.g., token limit) of the reply from the foundation model, and including instructions to focus the generative activity of the foundation model to mitigate digression, hallucination, and so on. The initial prompt may also task the foundation model with generating the completion in a parse-able format, such as enclosed within semantic tags or extensible Markup Language (XML) tags, for identification and extraction. In some scenarios, the output may be configured in a JavaScript Object Notation (JSON) data object of string values or other data structure.

When the completion is displayed and the user accepts the completion to the input, the content assistant generates a second prompt for the foundation model which includes the input and the completion. The output received by the content assistant in response to the second prompt is displayed in the user interface where the user can interact with the content. For example, if the task associated with the user input involves generating new content, the application populates the document with the new content in the appropriate location in the document according to the task or context information. If the task involves rewriting a portion of existing content in the document, the application populates the document by overwriting the portion of existing content. In some implementations, the foundation model is tasked with returning multiple completions. The multiple completions are displayed in the user interface where the user can select a completion for the user input. The content assistant configures the second prompt with the user input and the selected completion.

In various implementations, the content assistant is a tool, feature, or service of the application for generating content or for content analysis or insights, such as Copilot in Microsoft® Word. The content tool may be an AI-powered engine that is different from the foundation model (i.e., hosted by a different service on different servers). The user interface of the content assistant may be launched within the user interface of the application, such as a textbox or chat pane in the user interface by which the user can engage in a conversational exchange with the foundation model that is mediated by the content assistant. When launched, the user interface (e.g., input pane) of the content assistant may cue the user to enter input relating to a document displayed in the user interface.

When configuring the initial prompt for the foundation model, the content assistant includes a task associated with the user input. The content assistant may receive the task from a task engine of the application, or the content assistant may determine the task based on a selection made by the user, by content or other contextual information of the document, and/or by the location in the document where the content assistant interface was opened. For example, if the user has opened a blank document, the content assistant or task engine may identify a task of starting new content for the document (e.g., the task is to “Start”) and include the task, along with the user input, in the prompt for obtaining a completion. The contextual information for the initial prompt may include document metadata, such as a filename. In other scenarios, when the document includes existing content and the user has selected a portion of the existing content, the content assistant may present the user with the option of rewriting (e.g., “Rewrite”), summarizing (e.g., “Summarize”), or continuing (e.g., “Continue”) the content. Based on the user's selection of an option, the content assistant generates the initial prompt to include the indicated task, at least a portion of the existing content or the selected content for contextual information, and the user's natural language input. If, for example, the user or user input calls the content assistant between paragraphs of existing content, the content assistant may present the option to generate transitional content to smoothly transition between the paragraphs or to generate new content which logically fills in or connects the paragraphs (e.g., “Insert”). The task may be specified in the initial prompt as general or high-level task or as a content-specific task. The tasks may also be tailored or narrowed according to rules in the initial prompt, such as limiting the token limit of generated content according to the token size of the initial prompt (according to a combined token limit for the initial prompt and the output).

As another approach to contextualizing user input for content generation, the content assistant may mediate a conversational exchange between the user and the foundation model to identify or narrow in on a particular topic for the content to be created. In an exemplary scenario, if the content assistant receives a user's natural language input but is unable to suggest a completion due to latency or due to the input being completed before a suggestion can be surfaced, contextualizing the user input can then be accomplished by conversational exchange. In an implementation of conversational exchange for contextualization, upon receiving the user's natural language input (without a suggested completion), the content assistant may formulate a series of prompts to develop questions to be directed to the user to ascertain the user's intent to develop contextual information for the input. The user input together with the contextual information obtained from the follow-up questions are included in a complex prompt to obtain higher quality content from the foundation model.

In an illustration of conversional exchange, if the user begins an exchange with, “Can you help me write a new blog?”, the content assistant can serially prompt the foundation model to develop follow-up questions based on the user input and responses to the questions. In the process of prompting the foundation model, the content assistant may identify a parameter to be satisfied, such as receiving a predetermined number of questions and responses, which will trigger the submission of a more complex prompt to the foundation model for the actual content generation. For example, the content assistant may ask the foundation model in a series of prompts to generate three clarifying questions to dig into the user's intent. As the follow-up questions are displayed and user responses are received, the content assistant generates the complex prompt, including the displayed questions and user responses, which tasks the foundation model with generating the new content. The complex prompt may also include a task associated with the user input (e.g., “Start”) and other contextual information from the document. In some implementations, the content assistant may obtain the clarifying questions in response to a single prompt or to a series of prompts generated as each user response is received. In an implementation, the complex prompt is not displayed to the user; rather, the user sees only the conversational exchange in the input pane which provides the additional context for content generation.

In some scenarios, the user's natural language input may be keyed into the user interface or spoken by the user into an audio device (e.g., microphone) which is transcribed by a speech-to-text engine of the computing device on which the user interface is displayed. The application generates the initial prompt, including the natural language input, to task the foundation model with generating a continuation or completion of the input which refines, focuses, redirects, or otherwise augments the input to produce a higher quality output in accordance with existing content or other the contextual information and the task associated with the input. When the completion is returned to the application and ready for display, the application surfaces the suggested completion to the input in the user interface where the user may accept, modify, or reject the suggested completion. When the user accepts the completion, the application submits the input with the completion to the foundation model in a subsequent prompt to generate the requested output.

Foundation models of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Foundation models may be multimodal or unimodal depending on the modality or modalities of the inputs. Types of foundation models may be broadly classified as or include pre-trained models, base models, and knowledge models depending on the particular characteristics or usage of the model.

Multimodal models are a class of foundation model which leverages the pre-trained knowledge and representation abilities of foundation models to extend their capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image, for example, by using an image encoder to extract visual features, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Large language models (LLMs) are a type of foundation model which processes and generates natural language text. These models are trained on massive amounts of text data and learn to generate coherent and contextually relevant responses given a prompt or input text. LLMs are capable of sophisticated language understanding and generation capabilities due to their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are unique, open-ended, and unpredictable.

The technical effect of the technology disclosed herein for content assistance is to anticipate the user's intent which may not always be adequately captured in the user's natural language input and to generate new content which is of higher quality and/or of greater utility to the user. In addition to anticipating the user's intent, the technology presents a suggested completion to the user in a timely manner, that is to say, at an optimal time for presentation to avoid distracting the user by injecting the suggestion when the user is likely to have moved on from the thought.

To promote timely submission to and reply from the foundation model, the initial prompt generation performed by an application (e.g., by a content assistant of an application) is strategically designed for efficiency. The prompt includes a concise and focused set of rules or instructions for generating the output and limits the output size generated by the foundation model, such as specifying a token limit for the output (e.g., no more than 15 tokens). The initial prompt also tasks the foundation model with generating its reply according to a specified, parse-able format for efficient parsing. The application also generates the initial prompt by selectively including contextual information in a way that balances the size (e.g., token count) of the initial prompt with the quantity of existing content to be included in the prompt which will allow the foundation model to generate a more useful completion to the input. So, too, does limiting the token counts of the prompt and the output reduce processing and other costs of foundation model service interaction.

Moreover, the content assistance process streamlines the user's interaction with the foundation model. By presenting the completion to the user in association with the user input, such as a suggested completion appended to the input, the user can quickly consume and accept or reject the suggestion for rapid ideation or content creation but without disrupting or distracting the user's own creative process. More generally, generating completions to the user input which attempt to anticipate the user's needs or narrow in on the user's intentions also promotes more rapid convergence-achieving an optimal outcome with fewer foundation model interactions, thus reducing consumption of processing resources. The net of streamlined interaction, more rapid convergence, and optimized prompt sizing is faster performance by the foundation model giving rise to reduced latency and concomitant improvements to productivity costs and to the user experience.

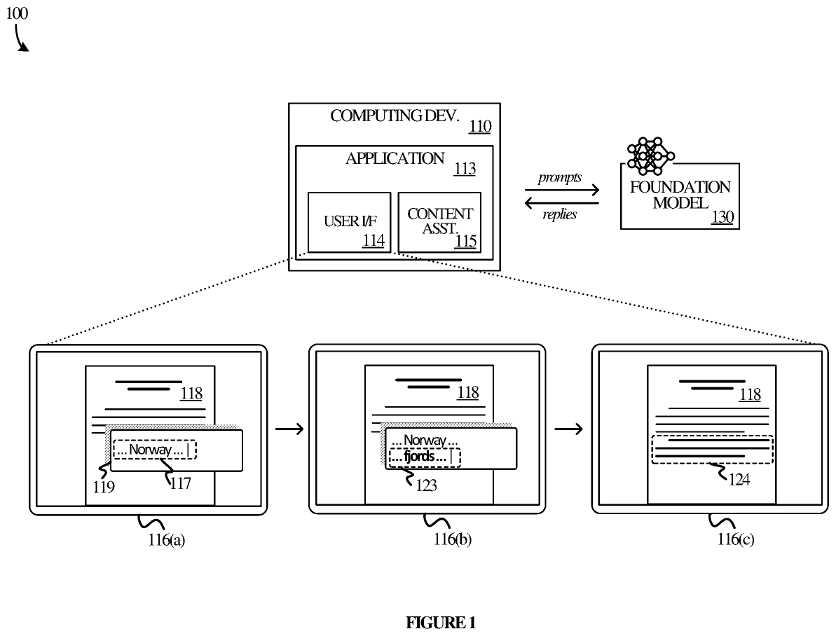

Turning now to the Figures, FIG. 1 illustrates operational environment 100 for a content assistance process, including input contextualization, via a foundation model integration in an implementation. Operational environment 100 includes computing device 110 which hosts application 113 including user interface 114 and content assistant 115. Computing device 110 is in communication with foundation model 130, including sending prompts to foundation model 130 and receiving output generated by foundation model 130 in accordance with its training. User interface 114 displays user experiences 116 (shown in various stages of operation as user experiences 116(a), (b), and (c)). User experiences 116(a), (b), and (c) display document 118 hosted by application 113. In user experiences 116(a) and 116(b), input pane 119 of content assistant 115 receives user input and displays output generated by foundation model 130.

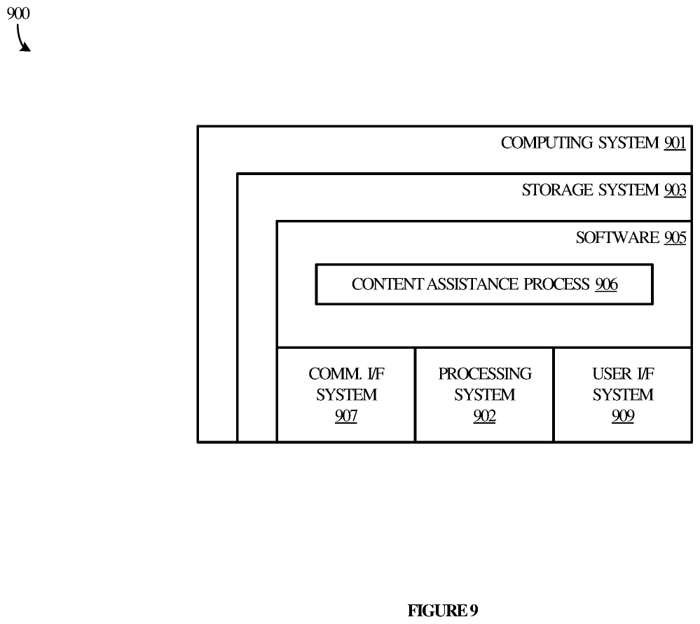

Computing device 110 is representative of a computing device capable of hosting application 113 and displaying or causing display of user interface 114 of application 113. Computing device 110 may be a user computing device, such as a laptop or desktop computer, or a mobile computing device, such as a tablet computer or smartphone, of which computing device 901 of FIG. 9 is representative. Computing device 110 may host application 113 which provides a local user experience, such as user experiences 116(a), (b) and (c), via user interface 114.

Application 113 is representative of a software application by which a user can create and edit text-based content, such as a word processing application, a collaborative or project application, or other productivity application, and which can generate prompts for submission to foundation models, such as foundation model 130. Application 113 may execute locally on a user computing device, such as computing device 110, or application 113 may execute on one or more servers in communication with computing device 110 over one or more wired or wireless connections, causing user experiences 116(a), (b), and (c) of user interface 114 to be displayed on computing device 110. In some scenarios, application 113 may execute in a distributed fashion, with a combination of client-side and server-side processes, services, and sub-services. For example, the core logic of application 113 may execute on a remote server system with user interface 114 displayed on a client device. In still other scenarios, computing device 110 is a server computing device, such as an application server, capable of displaying user interface 114, and application 113 executes locally with respect to computing device 110.

Application 113 executing locally with respect to computing device 110 may execute in a stand-alone manner, within the context of another application such as a presentation application or word processing application, or in some other manner entirely. In an implementation, application 113 hosted by a remote application service and running locally with respect to computing device 110 may be a natively installed and executed application, a browser-based application, a mobile application, a streamed application, or any other type of application capable of interfacing with the remote application service and providing user experiences such as user experiences 116(a), (b), and (c) displayed in user interface 114 on the remote computing device.

Foundation model 130 is representative of one or more computing services capable of hosting a foundation model computing architecture and communicating with computing device 110. Foundation model 130 may be implemented in the context of one or more server computers co-located or distributed across one or more data centers. Foundation model 130 is representative of a deep learning AI model, such as BERT, ERNIE, T5, XLNet, or of a generative pretrained transformer (GPT) computing architecture, such as GPT-3®, GPT-3.5, ChatGPT®, or GPT-4. Computing device 110 communicates with foundation model 130 via one or more internets and intranets, the Internet, wired or wireless networks, local area networks (LANs), wide area networks (WANs), and any other type of network or combination thereof. In some implementations, computing device 110 communicates with foundation model 130 via a cloud-based application service (not shown) hosting application 113 which executes content assistance processes and other processes of application 113. The content assistance processes may be executed by content assistant 115 of application 113 or of an application service hosting application 113.

In an exemplary operation scenario of operational environment 100 in FIG. 1, a user interacts with application 113 executing on computing device 110 via user interface 114 displaying user experiences 116. User experiences 116 display document 118, such as a word processing document or collaborative application canvas, hosted by application 113.

In user experience 116(a), application 113 receives natural language input 117 entered by the user in input pane 119 of content assistant 115. Natural language input 117 relates to content of document 118, such as a request for new content to be added to document 118, to revise existing content of document 118, for content ideas, etc. Application 113 generates a first prompt including natural language input 117 which is transmitted to foundation model 130. The first prompt tasks foundation model 130 with generating and returning a completion to the user's natural language input for presentation to the user in user interface 114. The first prompt includes a task identified by application 113 relating to natural language input 117. For example, a task engine (not shown) of application 113 may identify the task based on the user's invoking input pane 119 at the end of the existing content of document 118 or by the user's selection of a content insertion tool (not shown) in user interface 114. Context information in the first prompt may also include existing content from document 118, such as a paragraph near the insertion point of input pane 119. Context information can also include metadata for document 118, such as the filename.

Upon receiving the first prompt, foundation model 130 generates completion 123 to natural language input 117 and returns completion 123 to application 113. Application 113 displays completion 123 in association with natural language input 117, resulting in revised natural language input, in input pane 119 as illustrated in user experience 116(b). The user accepts the suggested completion by means of a user selection or input in input pane 119, such as tabbing over completion 123 and hitting the “Enter” key.

When application 113 receives an indication that the user has accepted completion 123, application 113 generates a second prompt for foundation model 130 tasking the model with generating output in response to the revised or contextualized natural language input (i.e., natural language input 117 and completion 123). Foundation model 130 returns a reply including content generated in response to the second prompt. Upon receiving the reply, application 113 displays the newly generated content 124 in user interface 114 in accordance with the task, such as adding the content to the existing content or overwriting existing content. As illustrated in user experience 116(c), application 113 populates document 118 with content 124 by adding it at the end of the existing content in the proximity of where input pane 119 was opened by the user.

In various implementations, the first and second prompts are generated by content assistant 115 of application 113 which interfaces with foundation model 130 (or with a service hosting foundation model 130). Content assistant 115 receives replies from foundation model 130 and processes the replies to extract completion 123 and content 124. Content assistant 115 or another service of application 113 may evaluate completion 123 for suitability (e.g., for insensitive or inappropriate content, for length, or for other characteristics), and surface completion 123 based on the evaluation. In various implementations, content assistant 115 tracks the time elapsed between generating the first prompt to processing the first prompt for display in input pane 119 so that completion 123 is displayed in a timely manner or discarded (i.e., not displayed) if excess latency is detected.

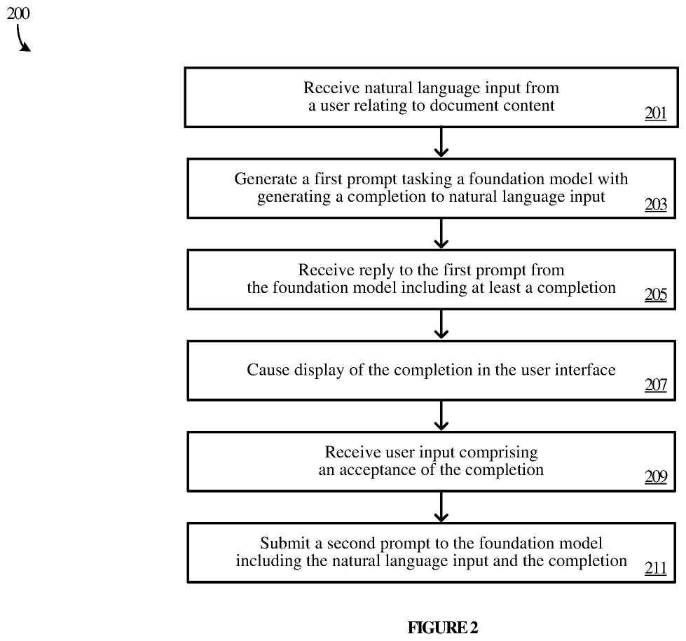

FIG. 2 illustrates a method of operating an application including a process for content assistance via a foundation model integration in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device receives natural language input relating to a document in the user interface of an application hosting the document (step 201). In an implementation, the user interface displays a document, such as a word processing document or a collaborative canvas. The user interface receives input from the user relating to the content of the document. For example, the user may select or open an insights tool or content assistant of the application which performs the steps of process 200 for assistance in creating content for the document. An input pane of the content assistant may be surfaced at a location in the document where the user would like assistance with the content. For example, the input pane may be surfaced at the end of the existing content where new content is to be added. In selecting or opening the content assistant, the user may indicate an action or task to be performed with respect to the existing content. In some scenarios, the document may be blank—lacking any existing content—and the user may open the content assistant for assistance with ideation or with getting started in content creation.

The computing device generates a first prompt which tasks a foundation model, such as an LLM, with generating a completion to the user's natural language input (step 203). In an implementation, the first prompt is generated according to a prompt template selected by the computing device and includes the user's natural language input, the task to be performed, and contextual information. In generating the first prompt, the computing device may include a portion or all of the natural language input and may task the foundation model with generating a logical and grammatically correct completion for the input. The prompt template selected by the computing device may include fields for the user input and other information for customizing the prompt along with rules or instructions by which the foundation model is to generate its output.

To identify or derive the task to be performed, the computing device may receive a task from a task engine of the application a task identified in association with the user input. In some implementations, the computing device may use factors to identify the task for inclusion in the first prompt, such as a user selection of an action in a content assistant of the application, the location of an insertion point in the document, or the location of an input pane of the content assistant into which the user enters input. For example, the user may open a content assistant for generating content, and select a desired action, such as “Insert,” “Rewrite,” “Start,” “Summarize,” etc. In other scenarios, if the user opens a content assistant between two paragraphs of existing content, the computing device may determine the task to be generating new content or generating transitional content. If the content assistant is opened at the end of the existing content, the computing device may determine that the task is to generate new content, a new topic, a conclusion or summary, and so on. In still other scenarios, if the content assistant is opened in a blank document, the tool may identify the task to be ideation.

In generating the first prompt, the computing device includes contextual information relating to the document, such as a selection of existing content (if any) which provides the foundation model with context for generating the completion. In an implementation, the computing device selects content for the first prompt according to a token limit of the first prompt, the quantity of available content, and a token limit on the output from the foundation model. For example, if there is an existing 500-word paragraph, the first prompt may include the entire paragraph without exceeding a token limit for the prompt. If, on the other hand, the document includes several pages of content, the computing device may select a portion of content at the end of the existing text if the task identified is to generate additional content. If the task is to generate transitional content or additional subject matter between two paragraphs, the computing device may select the paragraphs before and after the insertion point for inclusion in the prompt. In some scenarios, where the foundation model is multi-modal, the computing device may include one or more relevant figures from the document according to the task. In the case of a blank document, the contextual information provided by the computing device may be an indication that there is no existing content.

In an implementation, the first prompt is generated according to a prompt template which includes rules or instructions by which the foundation model is to generate its reply. The rules or instructions are directed to provide high quality output but also to minimize the processing time of the foundation model to reduce latency. For example, the first prompt may specify that the output be in a parse-able format, such as in a JSON object with the completion in the form of a string value or in XML or semantic tags, for efficient extraction. The first prompt may also constrain the size of the completion according to a token limit or number of words. Because the completion is to be surfaced in the user interface, the completion may be limited to, for example, ten words or less or no more than 20 tokens. The rules may also specify the language (e.g., English, Tier 1 countries, Tier 2 countries, etc.) and that the foundation model is to generate only the completion and nothing else.

With the first prompt configured, the computing device sends the first prompt to the foundation model and receives a reply to the first prompt which includes at least a completion (step 205). In an implementation, the computing device sends the first prompt to the foundation model or to a service hosting the foundation model via an application programming interface (API) of the foundation model. When the foundation model returns its reply, the computing device parses the output to extract the completion. For example, the first prompt may specify that the completion be enclosed in semantic tags (e.g., <t> and </t>) which allows the computing device to quickly identify and extract the completion.

Prior to surfacing the completion in the user interface of the application, the computing device may evaluate the completion with regard to the suitability of its content and with regard to the timeliness of surfacing the completion. For example, the computing device may evaluate the content of the completion for insensitive language which may be offensive to the user. The computing device may also track the elapsed time between generating the first prompt and surfacing the completion so that the surfacing is completed during a window of time deemed most useful to the user. For example, if the elapsed time is less than 800 milliseconds, the computing device may surface the completion, subsequent to evaluating its suitability, in the user interface. On the other hand, if the elapsed time exceeds 800 milliseconds, the computing device may discard the completion (i.e., not display the completion). In some scenarios, if the user continues to add text to the input before the completion is surfaced, the computing device may refrain from surfacing the completion and generate a new first prompt including the new version of the input.

In some scenarios, the first prompt may task the foundation model with generating multiple possible completions. For example, the first prompt may request three completions so that if the first completion is determined to be unsuitable, the computing device can then process a second completion from the reply, etc. In some implementations, the computing device may surface multiple completions so the user can select one for content generation.

Next, the computing device causes the completion to be displayed in association with the natural language input (step 207). In an implementation, when the computing device has extracted the completion from the reply to the first prompt, the computing device displays or causes the completion to be displayed in association with the user input. For example, where the user input is received in a textbox or input pane in the user interface, the completion may be displayed as a continuation of the input entered by the user but in such a way as to distinguish it from the input (e.g., bolded, highlighted, italicized, etc.). In some scenarios, when the completion is displayed, the input pane may receive user input editing the completion prior to submission.

The computing device may display the completion such that the user can accept or reject the completion. For example, the completion may be displayed with the user input in a text box where the user can enter the suggestion as presented (e.g., by pressing the “Enter” key), edit the suggestion prior to entering it, or deleting the suggestion to reject it. The user interface may also display buttons which when selected by the user allow the user to accept, edit, or reject the completion.

When the user accepts the completion or selects a completion from among multiple completions (step 209), the computing device generates and submits a second prompt including the natural language input and the completion to the foundation model (step 211). In an implementation, the computing device submits the second prompt to the foundation model tasking the model with generating content responsive to the input with the completion. The second prompt may specify the particular task and include contextual information as were included in the first prompt. Upon receiving the content generated in response to the second prompt, the computing device populates the document with the newly generated content according to the task, e.g., overwriting existing content, appending the new content to the existing content, and so on.

Returning to FIG. 1, operational environment 100 includes a brief example of process 200 as employed by elements of operational environment 100 in an implementation. Computing device 110 runs application 113 including causing user experiences 116 to be displayed via user interface 114. Application 113 may execute locally with respect to computing device 110, or computing device 110 may host application 113 which executes on one or more server computing devices remote from and in communication with computing device 110.

In operational environment 100, a user interacts with application 113 to generate content in document 118. Document 118 may be a word processing document in which the user is drafting textual content (e.g., an essay) or a collaborative canvas of a project or collaboration application. Application 113 includes services for generating content, such as content assistant 115 by which to generate content, ideas, or suggestions for the user in relation to document 118.

In creating and editing content in document 118, the user interacts with application 113 via user interface 114, including submitting natural language input 117 in input pane 119 of content assistant 115, as illustrated in user experience 116(a). In an implementation, the user invokes or calls content assistant 115 of application 113 by which to generate or revise content in document 118. Content assistant 115 surfaces input pane 119 at an insertion point where the user selected the tool. Input pane 119 includes a textbox for receiving natural language input 117 from the user and for displaying responses to the input generated by foundation model 130. Natural language input 117 may be keyed into input pane 119 or spoken into an audio device (e.g., microphone) of computing device 110 and transcribed to text by a speech-to-text engine. Content assistant 115 may also display tools in input pane 119 available to the user based on the content (or lack of) in the document, such as a graphical button for inserting newly generated content into document 118.

Continuing with the operational example, having received natural language input 117, application 113 generates the first prompt for foundation model 130 including a portion or all of natural language input 117, a task identified by application 113 relating to natural language input 117, and contextual information relating to document 118. The task identified by application 113 may be based on content in document 118, if any, a tool selected by the user in the process of submitting natural language input 117, a selection of text by the user in conjunction with a selection of a tool of application 113, the insertion point of input pane 119, and/or other factors. The contextual information includes a portion or all of existing content in document 118 and may also include metadata of document 118. The first prompt tasks foundation model 130 with generating a completion to natural language input 117 which may improve the quality of the output in response to a subsequent prompt to foundation model 130, such as suggestion for more specific content relating to the subject matter of document 118.

Upon submitting the first prompt to foundation model 130, content assistant 115 receives a reply from foundation model 130 including completion 123 for natural language input 117. Completion 123 comprises a suggested completion to or completion of natural language input 117 which refines or extends natural language input 117. Content assistant 115 parses the reply to extract completion 123. As illustrated in user experience 116(b), content assistant 115 surfaces completion 123 in association with natural language input 117 in input pane 119.

When the user supplies an input which indicates an acceptance of natural language input 117 with completion 123, content assistant 115 generates a second prompt which tasks foundation model 130 with generating a reply responsive to the second prompt. The reply to second prompt from foundation model 130 includes newly generated content 124 which is extracted by content assistant 115 for inclusion in document 118. As illustrated in user experience 116(c), content 124 may be appended to the existing content of document 118, but in some implementations, content generated by foundation model 130 may be used in other ways, such as overwriting existing content.

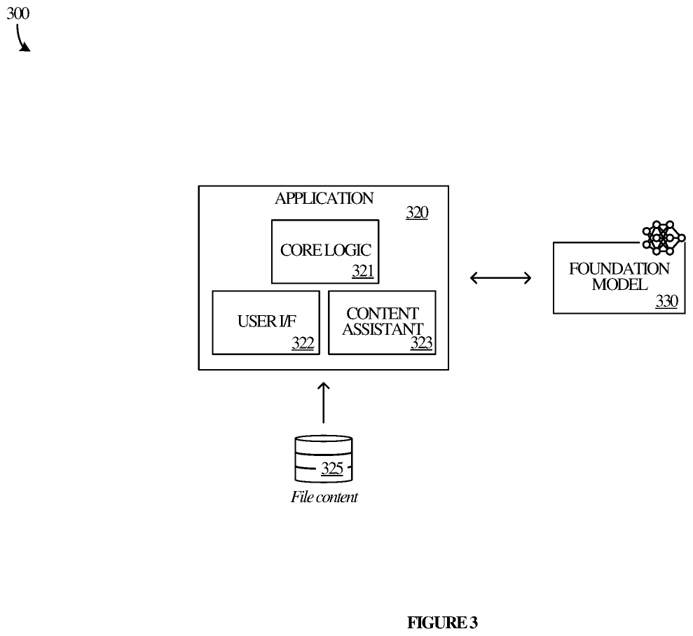

FIG. 3 illustrates system architecture 300 for a content assistance process, including input contextualization, via a foundation model integration in an implementation. Systems architecture 300 includes application 320 with core logic 321, user interface 322, and content assistant 323. Application 320 or core logic 321 may include other engines or services, such as a task engine (not shown). Content assistant 323 may include engines or services, such as a prompt generation engine (not shown). Application 320 is representative of a software application by which a user can create and edit text-based content, such as a word processing application, a collaborative or project application, or other productivity application. Application 320 may execute locally on a user computing device (not shown), or application 320 may execute on one or more servers (not shown) in communication with the user computing device, causing user interface 322 to be displayed on the user computing device. In some scenarios, application 320 may execute in a distributed fashion, with a combination of client-side and server-side processes, services, and sub-services, such as core logic 321 executing on a remote server system and user interface 322 executing on a client device. In some scenarios, application 320 executes on a server computing device with a display screen for displaying user interface 322.

Foundation model 330 of systems architecture 300 is representative of an artificial intelligence model, such as a transformer model, which receives textual input and which is trained to generate content responsive to the input. Foundation model 330 can include language models, multimodal models, or other types of deep learning or generative transformer models. Foundation model 330 receives prompts from content assistant 323 and generates output in accordance with the prompts. Foundation model 330 may be hosted by a foundation model service which communicates with content assistant 323 via an API.

In operation, application 320 causes user interface 322 to be displayed on the user computing device providing user experiences similar to those of user experiences 116 of FIG. 1. Content assistant 323 of application 320 communicates with foundation model 330, including configuring prompts for submission to foundation model 330 and receiving output from foundation model 330. Content assistant 323 causes an input pane to be displayed in user interface 322 for receiving user input and displaying completions from foundation model 330. Core logic 321 of application 320 performs functions which allow a user to interact with the document in creating and revising content. Application 320 displays instances of documents in user interface 322 where the user can generate and revise content. Documents hosted by application 320 may be persisted to storage in storage device 325.

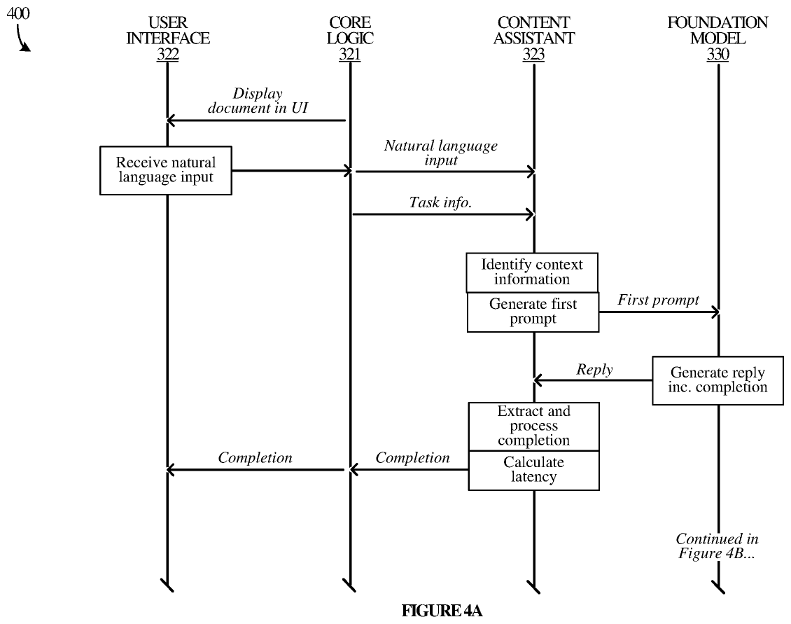

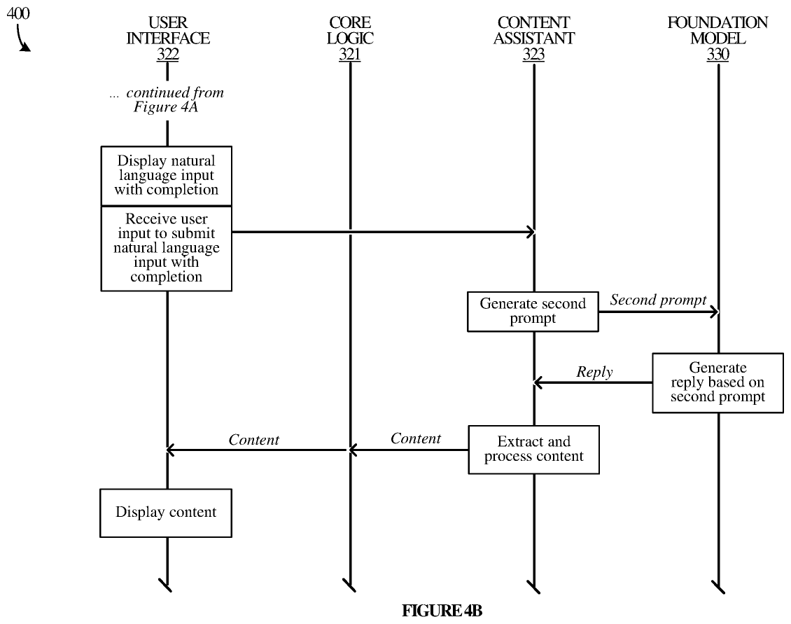

FIGS. 4A and 4B illustrate operational scenario 400 for content assistance processes via foundation model integrations in an implementation, referring to elements of systems architecture 300 in FIG. 3. In operational scenario 400 in FIG. 4A, a document is displayed in user interface 322, and application 320 receives user input relating to the document via user interface 322. The user enters a natural language input relating to the document in the input pane of content assistant 323 in user interface 322. In an implementation, content assistant 323 may iteratively (re) generate a first prompt as the user enters his/her input. For example, content assistant 323 may be called by application 320 to generate a first prompt when the user pauses his/her input for a specified interval of time (e.g., one second). If the user continues to enter the input prior to submission of the first prompt, content assistant 115 may revise the first prompt with the updated input. Alternatively, content assistant 115 may (re) generate the first prompt at regular intervals of time or character entry as the user input is received. With each prompt generation or regeneration, the content assistant process continues as described below.

Upon receiving the natural language input, content assistant 323 generates the first prompt to obtain a completion to the input from foundation model 330. To generate the first prompt, content assistant 323 receives task information from core logic 321. For example, core logic 321 may receive task information from a task engine of application 320. Content assistant 323 may receive context information from core logic 321 or it may determine context information for the first prompt based on selected content of the document (e.g., a paragraph from the document), document metadata, document content which the user has highlighted in association with the user input, and so on. Content assistant 323 may generate the first prompt based on a prompt template which includes rules or instructions which specify how foundation model 330 is to generate its output. For example, the rules may include a token limit for the output, an output format, and a particular language. With the first prompt created, content assistant 323 transmits the prompt to foundation model 330.

Upon receiving the first prompt from content assistant 323, foundation model 330 generates a response including the requested completion to the user input in a specified format. Foundation model 330 returns the response to content assistant 323 which parses the reply to extract the completion to the natural language input. Content assistant 323 processes the completion, including evaluating the completion for suitability (e.g., appropriate content, insensitive language, length, etc.) and generating a version of the completion for display in the input pane in user interface 322.

Subsequent to processing the completion, content assistant 323 computes an elapsed time or latency for displaying the completion in user interface 322 from the time the user input is received. For example, the elapsed time may be computed as the time between generating the first prompt and processing the completion for display or between submitting the first prompt to the foundation model and a time when the completion for display. If the elapsed time is below a threshold value (e.g., 800 milliseconds), content assistant 323 sends the completion to be displayed in user interface 322. If, however, the latency exceeds the threshold value, the completion is discarded without display.

Continuing operational scenario 400 in FIG. 4B, user interface 322 displays the completion as a continuation of the user input, distinguishing the completion from the user input by using a different font style and such that the completion is selectable (e.g., as a hyperlink). With the completion displayed, the user may accept, modify, or reject the completion to the input. The user may, for example, submit the input with the completion by clicking an “Accept” button displayed with the text box or by hitting the “Enter” key when the text box is in focus. When application 320 receives the user input submitting the input with the completion, content assistant 323 generates a second prompt for foundation model 330 for generating content for the document that is responsive to the now-revised input (i.e., the input with the completion). The second prompt may task foundation model 330 with generating its output according to a token limit (e.g., no more than 500 tokens), in a particular format (e.g., enclosed in semantic tags or in a JSON object), and/or in a particular language. Content assistant 323 submits the second prompt to foundation model 330 which generates and returns a reply in accordance with the second prompt. When content assistant 323 receives the reply, it extracts the newly generated content from the reply according to the specified format and processes the output for suitability (e.g., appropriate content, insensitive language, length, etc.). Subsequent to finding the output suitable for display, content assistant 323 sends the content for display in user interface 322.

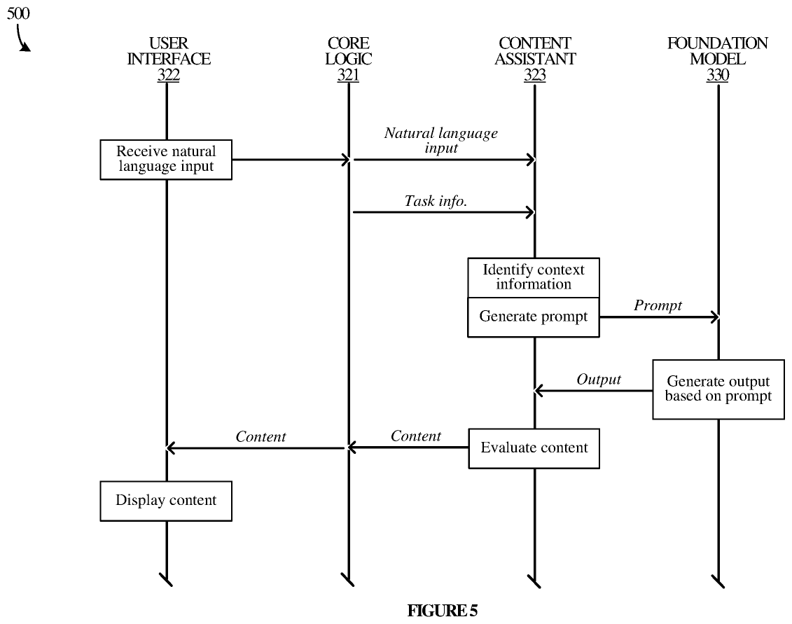

FIG. 5 illustrates an operational scenario 500 for a content assistance process via a foundation model integration in an implementation, referring to elements of FIG. 3. Operational scenario 500 may be a continuation of operational scenario 400. For example, subsequent to generating the second prompt for content based on the user input and the completion, the user may submit a new natural language input which causes a third prompt to be generated by content assistant 323.

In operational scenario 500, the user enters a new natural language input in the input pane of content assistant 323 in user interface 322. Core logic 321 sends the user input along with task information to content assistant 323 by which to generate a (third) prompt. The task information may be obtained from a task engine of core logic 321 which identifies a particular task associated with the natural language input. For example, if the natural language input is received in association with the user having selected text from the document content, the task information may be determined by the insights tool to be a “Rewrite” task. Alternatively, the user may select a tool of core logic 321 which indicates the task, such as a task to “Insert” new content at a particular location in the document. In some scenarios, the task engine of core logic 321 may determine that the task is to “Start” new content on the basis of the document having no content. Content assistant 323 may receive context information from core logic 321 or it may determine context information for the (third) prompt based on selected content of the document (e.g., a paragraph from the document), document metadata, document content which the user has highlighted in association with the user input, and so on.

When content engine 323 transmits the (third) prompt to foundation model 330, foundation model 330 returns a reply including content for the document. Content assistant 323 extracts the content generated according to the (third) prompt, which is then evaluated by core logic 321 for suitability prior to display. If the content is deemed suitable (e.g., does not violate policy rules with regard to sensitivity), user interface 322 displays the content. In some scenarios, core logic 321 may populate the document according to the task, such as overwriting existing text in accordance with a Rewrite task or inserting the text according to an Insert or Start task.

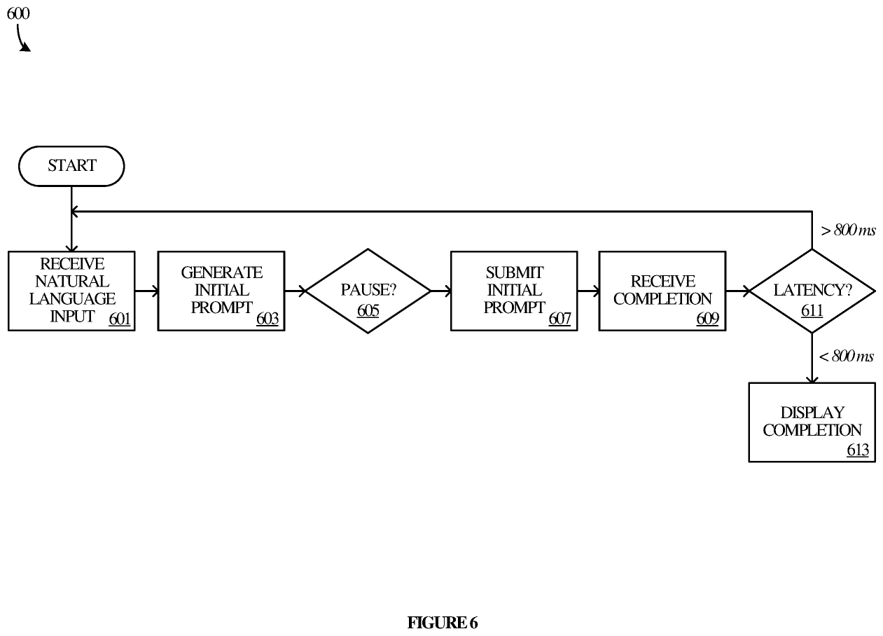

FIG. 6 illustrates workflow 600 for displaying a completion generated by a foundation model based on latency in an implementation. Workflow 600 may be performed by an application or a content assistant of an application receiving user input for creating content for a document hosted by the application, of which application 113 and content assistant 115 of application 113 of FIG. 1 are representative, in an implementation.

In workflow 600, a user enters a natural language input into an input pane of a content assistant (step 601). When the user begins to enter the input, the content assistant generates a first prompt which tasks a foundation model with generating a completion to the input (step 603). As the user is entering the input (by keying in the input or speaking the input), the content assistant monitors the input entry for an event which will trigger submission of the first prompt to the foundation model, such as a pause of a specified duration (step 605). Upon detecting a pause in the entry, the content assistant submits the initial prompt including the user input to the foundation model (step 607). The content assistant receives a reply to the initial prompt from the foundation model (step 609). The content assistant may process the reply to extract the requested completion and to evaluate the completion for suitability.

When the completion is ready for display, the content assistant computes a latency for displaying the completion (step 611). In an implementation, the content assistant computes the latency as the time elapsed between the pause (or other trigger event) and the time when the completion is ready for display. If the latency is less than a threshold amount (e.g., 800 milliseconds), the content assistant causes the completion to be displayed in the user interface (step 613). If, however, the latency is greater than the threshold amount, the completion is discarded without display, and the content assistant returns to receiving the user input and handling the user input without the completion. For example, the content assistant may configure a second prompt tasking the foundation model with generating content for the document based on the user input (without a completion), a task associated with the user input, and contextual information.

Other events which may trigger the submission of the initial prompt may be based on the rate of entry of characters in the input or on an interval of time as the user enters the input. For example, the content assistant may (re) generate the initial prompt as the entry of the input continues and submit the prompt when a particular character (e.g., a period, a space) is received. In some scenarios, the initial prompt may be (re) generated and (re) submitted each time a certain number of characters is submitted. For example, the initial prompt may be (re) generated and (re) submitted every five characters. With multiple submissions, the content assistant may process only the last reply received and discard any earlier replies.

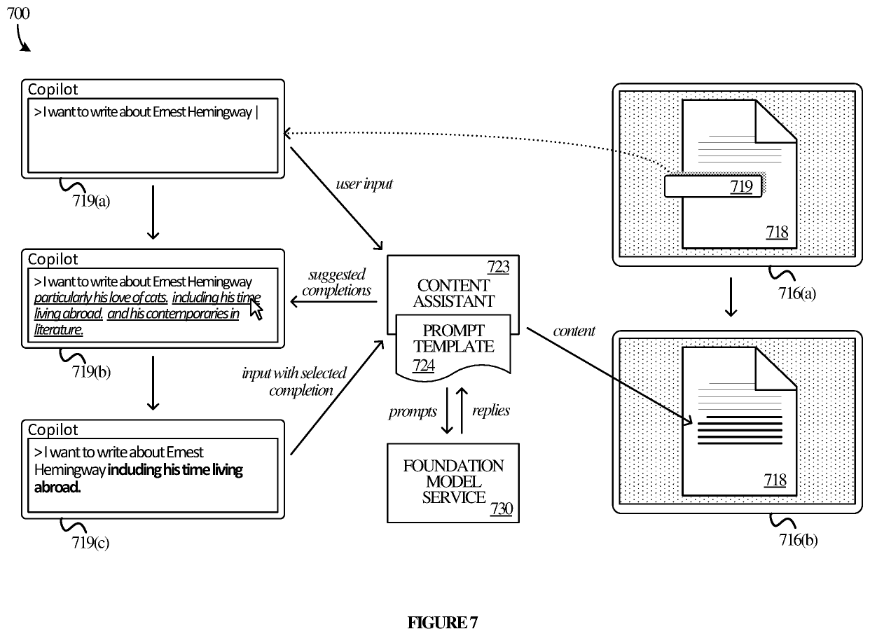

FIG. 7 illustrates operational scenario 700 for content assistance processes including input contextualization in an implementation. In operational scenario 700, document 718 is displayed in user interface 716(a) of an application (not shown) of which application 113 of FIG. 1 is representative. In user interface 716(a), input pane 719(a) of content assistant 723 (labeled “Copilot”) of the application is displayed including a textbox for receiving the user's natural language input. As the user keys in a natural language input, content assistant 723 of the application generates a first prompt according to prompt template 724 which tasks a foundation model of foundation model service 730 with generating a completion to the input. In some scenarios, content assistant 723 may generate the first prompt as the user keys in the natural language input and submit the first prompt when content assistant 723 detects that the user has paused for a specified amount of time (e.g., one second). In an implementation, the first prompt is generated prior to the user submitting or committing the input, e.g., by hitting “Enter”; the first prompt is not submitted once the user submits or commits the input.

With a first prompt generated, content assistant 723 submits the first prompt to foundation model service 730. Foundation model service 730 returns a reply including, as illustrated in input pane 719(b), three suggested completions to the input. Content assistant 723 surfaces the completions in association with the natural language input in input pane 719(b). As illustrated in input pane 719(b), the completions are displayed in a different character style to distinguish them from the user input (e.g., as hyperlinks). With the completions surfaced in input pane 719(b), the user selects a suggested completion which aligns with the user's intentions (as illustrated, the user selects “and his time living abroad.”). The user may also edit, alter, or delete a suggested completion prior to accepting or submitting the contents of input pane 719(c).

When the application receives user input to submit the natural language input with the selected completion, content assistant 723 generates a second prompt which is submitted to foundation model service 730. Content generated by the foundation model in response to the second prompt is received by content assistant 723 which then populates document 718 with the content, as depicted in user experience 716(b).

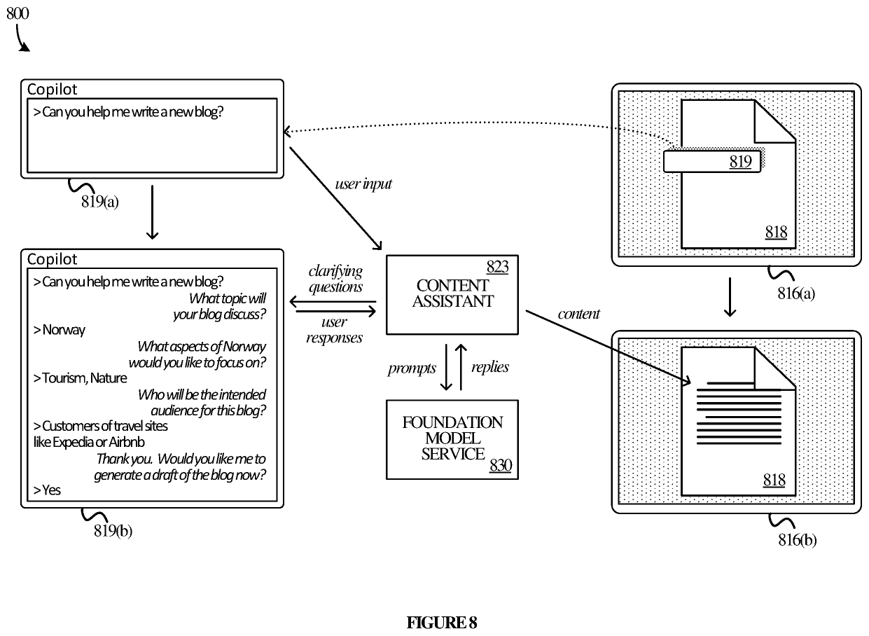

FIG. 8 illustrates operational scenario 800 for content assistance processes including input contextualization in an implementation. In operational scenario 800, document 818 is displayed in user interface 816(a) of an application (not shown) of which application 113 of FIG. 1 is representative. In user interface 816(a), input pane 819(a) of content assistant 823 (labeled “Copilot”) of the application is displayed including a textbox for receiving the user's natural language input. When the user enters the natural language input in input pane 819(a) or when content assistant 823 detects that completion character is entered, content assistant 823 of the application initiates a conversational exchange between the user and a foundation model of foundation model service 830. (In an exemplary implementation, it may be assumed that the user input was received before content assistant 823 was able to surface a suggested completion.) Content assistant 823 generates a series of prompts each of which tasks the foundation model of foundation model service 830 with generating clarifying questions to contextualize the user input. When each question is generated and displayed, a response from the user is received. Each subsequent prompt includes the preceding questions and responses. To generate the questions, each prompt may task the foundation model with narrowing the topic, identifying an audience, identifying a viewpoint (e.g., persuasive, neutral), and so on. The prompt may include instructions to limit the size (e.g., token size) of the questions for the user to quickly read them and to minimize latency. In some implementations, content assistant 823 generates a given number of prompts (e.g., three) to obtain a given number of questions from the foundation model, at which point the user is prompted to confirm that the content is to be generated based on the exchange.

Input pane 819(b) displays the conversional exchange after three prompts have been submitted to foundation model service 830, three clarifying questions have been generated and displayed, and a user response received for each question. With a given number of questions and responses received, content assistant 823 asks the user if the draft should be generated. At this point, the user responds “Yes” and content assistant 823 configures a fourth prompt for submission to foundation model service 830 for content generation. The fourth prompt includes the conversational exchange (as illustrated in input pane 819(b)) along with other contextual information from the document (e.g., a lack of any existing content) and, in some cases, a task associated with the input (e.g., “Start”). Upon submitting the fourth prompt to foundation model service 830, content assistant 823 receives the requested content which the application uses to populate document 818, as shown in user experience 816(b). In some implementations, had the user answered “No” in response to the fourth question, content assistant 823 selects a prompt template (not shown) for responses other than “Yes” to continue the dialog.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements content assistance process 906, which is representative of the content assistance processes and workflows discussed with respect to the preceding Figures, such as process 200 and workflow 600. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including content assistance process 906) may be implemented in program instructions and among other functions may, when executed by processing system 902, direct processing system 902 to operate as described with respect to the various operational scenarios, sequences, and processes illustrated herein. For example, software 905 may include program instructions for implementing content assistance processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support content assistance processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive natural language input from a user relating to content of a document in a user interface of an application;
generate a first prompt to elicit a reply from a foundation model, wherein the first prompt elicits from the foundation model at least a completion to the natural language input, wherein the first prompt includes at least a portion of the natural language input, a task associated with the natural language input, and context information associated with the document;
receive the reply to the first prompt from the foundation model, wherein the reply comprises the completion to the natural language input;
cause display of the completion in association with the natural language input in the user interface;
receive user input comprising an indication to combine the natural language input with the completion, resulting in revised natural language input; and
submit, to the foundation model, a second prompt comprising the revised natural language input.

2. The computing apparatus of claim 1, wherein the program instructions further direct the computing apparatus to:
receive a second reply generated by the foundation model in response to the second prompt; and
populate the document with content from the second reply according to the task.

3. The computing apparatus of claim 2, wherein the program instructions further direct the computing apparatus to track an elapsed time from when the first prompt is submitted to the foundation model to when the completion is ready for display in the user interface.

4. The computing apparatus of claim 3, wherein to cause display of the completion in the user interface, the program instructions direct the computing apparatus to cause display of the completion in the user interface when the elapsed time is less than a threshold value.

5. The computing apparatus of claim 4, wherein the program instructions further direct the computing apparatus to:
receive a second natural language input in the user interface;
generate a third prompt to elicit a third reply from the foundation model, wherein the third prompt elicits from the foundation model at least a completion to the second natural language input, a second task associated with the second natural language input, and the context information associated with the document; and
receive the third reply to the third prompt from the foundation model, wherein the third reply comprises the completion to the second natural language input;
determine that a second elapsed time from when the third prompt was submitted to the foundation model to when the completion was ready for display exceeds the threshold value; and
discard the completion based on the second elapsed time exceeding the threshold value.

6. The computing apparatus of claim 5, wherein the program instructions further direct the computing apparatus to evaluate the completion for suitability.

7. The computing apparatus of claim 1, wherein the context information includes a portion of the content from the document selected based on the task associated with the natural language input.

8. The computing apparatus of claim 1, wherein the program instructions further direct the computing apparatus to submit the first prompt to the foundation model when the computing apparatus detects a triggering event while receiving the natural language input in the user interface.

9. A method, comprising:
receiving natural language input from a user relating to content of a document in a user interface of an application;
generating a first prompt to elicit a reply from a foundation model, wherein the first prompt tasks the foundation model with generating at least a completion to the natural language input and wherein the first prompt includes at least a completion to the natural language input, a task associated with the natural language input, and context information associated with the document;
receiving the reply to the first prompt from the foundation model, wherein the reply comprises the completion to the natural language input;
causing display of the completion in association with the natural language input in the user interface;
receiving user input comprising an indication to combine the natural language input and the completion, resulting in a revised natural language input; and
submitting, to the foundation model, a second prompt comprising the revised natural language input.

10. The method of claim 9, further comprising:
receiving a second reply generated by the foundation model in response to the second prompt; and
populating the document with content from the second reply according to the task.

11. The method of claim 10, further comprising tracking an elapsed time from when the first prompt is submitted to the foundation model to when the completion is ready for display in the user interface.

12. The method of claim 11, wherein causing display of the completion in the user interface comprises causing display of the completion in the user interface when the elapsed time is less than a threshold value and discarding the completion when the elapsed time is greater than the threshold value.

13. The method of claim 12, further comprising:
receiving a second natural language input in the user interface;
generating a third prompt to elicit a third reply from the foundation model, wherein the third prompt elicits from the foundation model at least a completion to the second natural language input, a second task associated with the second natural language input, and the context information associated with the document;
receiving the third reply to the third prompt from the foundation model, wherein the third reply comprises the completion to the second natural language input;
determining that a second elapsed time from when the third prompt was submitted to the foundation model to when the completion was ready for display exceeds a threshold value; and
discarding the completion based on the second elapsed time exceeding the threshold value.

14. The method of claim 13, further comprising evaluating the completion for suitability.

15. The method of claim 9, wherein the context information includes a portion of the content of the document selected based on the task associated with the natural language input.

16. The method of claim 9, further comprising submitting the first prompt to the foundation model based on detecting a triggering event while receiving the natural language input in the user interface.

17. One or more computer-readable storage media having program instructions stored thereon that, when executed by one or more processors of a computing device, direct the computing device to at least:
receive natural language input from a user relating to content of a document in a user interface of an application;
generate a first prompt to elicit a reply from a foundation model, wherein the first prompt tasks the foundation model with generating at least a completion to the natural language input and wherein the first prompt includes at least a portion of the natural language input, a task associated with the natural language input, and context information associated with the document;
receive the reply to the first prompt from the foundation model, wherein the reply comprises the completion to the natural language input;
cause display of the completion in association with the natural language input in the user interface;
receive user input comprising an indication to combine the natural language input and the completion, resulting in a revised natural language input; and
submit, to the foundation model, a second prompt comprising the revised natural language input.

18. The one or more computer-readable storage media of claim 17, wherein the program instructions further direct the computing device to:
receive a second reply generated by the foundation model in response to the second prompt; and
populate the document with content from the second reply according to the task.

19. The one or more computer-readable storage media of claim 18, wherein the program instructions further direct the computing device to track an elapsed time from when the first prompt is submitted to the foundation model to when the completion is ready for display in the user interface.

20. The one or more computer-readable storage media of claim 19, wherein to display the completion in the user interface, the program instructions direct the computing device to display the completion in the user interface based on the elapsed time.
